(19) United States
(12) Patent Application Publication
(10) Pub. No.: US 2011/0295756 A1
(43) Pub. Date: Dec. 1, 2011

(54) FLEXIBLE EXTENDED PRODUCT WARRANTIES HAVING PARTIALLY REFUNDABLE PREMIUMS

(76) Inventors: Julie Ward Drew, Redwood City, CA (US); Ruxian Wang, New York, NY (US); Guillermo Gallego, Waldwick, NJ (US); Ming Hu, Toronto (CA); Enis Kayis, East Palo Alto, CA (US); Filippo Balestrieri, Mountain View, CA (US); Shelen Jain, Cupertino, CA (US); Jose Luis Beltran Guerrero, Palo Alto, CA (US); Douglas M. Gilbert, Los Gatos, CA (US)

(21) Appl. No.: 12/789,314

(22) Filed: May 27, 2010

(51) Int. Cl. G06Q 10/00

(52) U.S. Cl. 705/302; 705/348

(57) ABSTRACT

A system and method for determining the optimum price that a service provider should charge to customers of at least a partially refundable extended-product warranty to optimize profits generated from providing such warranties. In one aspect of the present invention the customer may elect to purchase warranty coverage when the product is new and cancel warranty coverage at any time thereafter, which election is based in part on the customer's expected discounted net utility from his coverage decisions. In another aspect of the present invention, the customer is allowed to make dynamic repair or replacement decisions in each period based on the product's failure status or on other criteria. In one embodiment, the customer can be afforded warranty coverage flexibility in terms of his ability to turn coverage off whenever desired and to obtain a partial refund of the warranty premium. By properly modeling extended-product warranty strategies from the perspective of the customer and from the perspective of the service provider, one can compute the customers' expected discounted net utility and the provider's expected discounted profit from strategic customers. In another aspect of the present invention a computer-based service is provided to the customer of the extended-product warranty for determining the customer's optimal dynamic decisions to maximize the customer's expected discounted net utility when making product replacement decisions, maintenance decisions, and warranty coverage decisions.

### CROSS-REFERENCE TO RELATED APPLICATIONS

This application is related to a nonprovisional application Ser. No. ______, filed on the same day as this application and entitled, “Flexible Extended Product Warranties.”

### BACKGROUND OF THE INVENTION

The present invention relates generally to the field of Operations Research and Dynamic Programming (DP) of real-life decision problems such as product warranties. More particularly the present invention relates to flexible product warranties where customers can select and pay for warranty coverage on a monthly basis or on some other limited time period other than the customary annual or multi-year contracts.

As manufacturers (OEMs) face decreasing profit margins on sophisticated hardware products, post-sale services like extended warranties (EWs) are becoming increasingly important to an OEM's profitability. In addition to providing higher profit margins than typical hardware sales, EW service contracts help to extend the useful life of products, generate a profitable revenue stream of consumables and accessories over the lifetime of the original product, and provide an opportunity to improve customer loyalty whether the customer is an average consumer or another business entity. But many customers along with consumer rating agencies often view EWs as offering poor value to customers. This perception may be partly due to the fact that most warranties are offered at a uniform price regardless of how products are used, whether the products are for industrial or consumer usage, and are often only offered in increments of 1 to 3 years of coverage beyond the base-warranty period. This inflexible arrangement requires the customer to commit and pay for up-front costs for the entire warranty period. From an operation's research perspective the customer is asked to make a trade off at the time of product purchase to minimize current costs while taking into consideration the future costs of repair. This is usually very difficult since most customers are often unsure of a product's reliability, but they would like the peace of mind knowing that for at least the period of coverage beyond the base warranty, they will not have to incur future and often expensive repair costs. This is particularly important for the business user on a tight budget since expensive repair costs can bankrupt a business. And to further complicate the EW decision, in industries with rapid technological innovation, such as consumer electronics, customers may not know how soon they may wish to upgrade to a newer product with more features. Product lifecycles are continually shrinking and are in some businesses down to less than a year, e.g., cell phones. Thus it may not be an optimal strategy for a customer to commit to a multi-year EW in a rapidly changing product environment.

All of these issues could be substantially addressed through a monthly or quarterly EW if properly designed. A monthly warranty allows customers to choose the duration of coverage with finer granularity, and more importantly, the customer only has to commit and pay on a monthly or other short-term basis for the warranty coverage. From a customer's perspective it reduces the complexity of minimizing current costs while taking into consideration the future costs of repair. Such an EW would be purchased while the product is still new or at least still under the base warranty, but the customer could cancel it at various times during the life of the contract and may even be allowed to receive a partial refund if repairs have been nonexistent. This arrangement could be very attractive to a much broader range of customers who have never considered EWs in the past.

For a traditional service provider who sells warranties with one or more full-years of coverage, the introduction of flexible monthly EWs has its hazards since monthly contracts may cannibalize demand for the traditional long-term EWs. Therefore, flexible EWs need to be carefully designed and properly priced in order to avoid eroding profits. It is crucial to properly characterize the potential costs and economic decisions in such an environment if the service provider is to maximize profits. If a flexible EW is priced too high, most customers would not find it attractive and would not sign up for the coverage. If priced too low, the customers may like it, but the EW service provider would lose money over the life of the EW contract. Although there have been numerous studies and papers written where EWs have been modeled, there have been very few studies that properly model optimal EW strategies whether from the perspective of the customer or from the perspective of the manufacturer/service provider. And very few of these deal with flexible EW contracts or for the situation where a customer can make dynamic repair or replacement decisions in each covered or uncovered payment period. Our modeling tool, as will be seen, allows customers to make dynamic repair or replacement decisions in each period, based on the product's failure status or on other criteria. (As product prices decline as a result of competition and technology innovations, product replacement is becoming an increasingly viable alternative to costly repairs and EW coverage.)

Further limitations and disadvantages of conventional and traditional approaches will become apparent to one skilled in the art, through comparison of such devices with a representative embodiment of the present invention as set forth in the remainder of the present application with reference to the drawings.

### BRIEF DESCRIPTION OF THE DRAWINGS

For a better understanding of the invention as well as further features thereof, reference is made to the following description which is to be read in conjunction with the accompanying drawings wherein:

FIGS. 1A and 1B show a flow diagram depicting a method for determining a customer's optimal dynamic decisions to maximize their expected discounted net utility when making product replacement and warranty coverage decisions in accordance with a representative embodiment of the present invention.

FIGS. 2A and 2B show another flow diagram depicting a method for determining a service provider's potential profitability from making customer product repairs, product replacements and warranty costs considering the customer's strategic behavior in accordance with a representative embodiment of the present invention.

FIG. 3A is a table of failure probabilities, fₐ, versus product age given a particular numerical example to illustrate the customer's expected discounted net utility and the service provider's expected discounted profits resulting from a monthly EW in accordance with a representative embodiment of the present invention.

FIG. 3B is a table showing the customer utility uₐ from a functional product versus the product's age of “a” months for a particular numerical example used to illustrate a representative embodiment of the present invention. The various customer types shown in FIG. 4B are used to show the varying utilities versus time between someone who really likes to own the newest technology (customer type j=5) and someone who does not lose much utility as the product ages (customer type j=1).

FIG. 4A is a table of calculated values for a class 2 customer showing the customer's expected discounted value (or net utility) Vₙ(S) where S denotes the state of the product over the next n months before making a replacement decision given a particular numerical example for illustrating a representative embodiment of the present invention.

FIG. 4B is a table of optimal coverage decisions for a class 2 customer when n=13 for different product ages of “a” months calculated using the same particular numerical example to illustrate a representative embodiment of the present invention showing a customer's expected discounted utility values and optimal warranty purchase decisions, at different product age where n=13 months remaining.

FIG. 5A is a table used to illustrate a representative embodiment of the present invention showing a customer's expected discounted utility values Vₙ(S) and maintenance decisions, at different product ages where n=13 months remaining. It is calculated assuming the product is nonfunctioning, is not covered by an EW, and the cost to repair is $50.

FIG. 5B is a table used to illustrate a representative embodiment of the present invention showing a customer's expected discounted values Vₙ(S) for different product replacement decisions, and the optimal product replacement decision, where n=13 months remaining and is calculated assuming the product is still functioning and covered by an EW.

FIG. 5C is a table used to illustrate a representative embodiment of the present invention showing a service provider's total discounted expected profit of VΠₙ from a customer starting in state (c, a, Z) with n=12 months remaining and where the product age is a=5.

FIG. 6 is a block diagram of a system implementing a commercial service for identifying a customer's optimal dynamic decisions in accordance with an embodiment of the present invention.

### DETAILED DESCRIPTION

Reference will now be made in detail to a representative embodiment of the present invention shown generally in the accompanying drawings. Furthermore, in the following detailed description, numerous specific details are set forth in order to provide a thorough understanding of the present invention. However, it will be obvious to one of ordinary skill in the art that the present invention can be practiced without these specific details.

To understand the underlying methods disclosed, it is first necessary to define some basic assumptions and the notation used in the Figures and in the modeling framework. We consider a customer who has just purchased a new product, for example something like a personal computer, and who would like to maximize the expected discounted net utility derived from this product over a finite period of time defined as a time horizon of N periods. A period may represent a month, a week, a quarter of a year, or any other fixed duration of time. In each such period the customer makes certain maintenance, replacement, and coverage decisions about the product. If it is broken, should it be repaired or should it be replaced with a newer model? Should the customer buy EW coverage for it assuming such is available?

In the following description, we use the following terminology to define the key expressions and variables involved in the customer and service provider decisions.
Time is divided into a series of periods, where n=0, . . . , N and represents the finite number of periods to go until the end of the horizon as defined by the duration of time over which the customer wants to maximize his expected discounted utility. For example the horizon may be a number of months over which the customer expects to own a personal computer or the type of product in question. The elapsed time in the horizon with n periods to go is represented by N−n.
Age: the age of a product is expressed as a and is the incremental age of the product measured from the time when the customer first receives the product (a=0). It is measured in terms of a number of time periods, e.g., months.
Product utility: the customer extracts utility uₐ from a functional product during a month when the product's age is a periods, such as months. We define utility only in terms of product age and not the time period. If we want to impose a limited lifespan of ã periods for the product, we can simply set uₐ=0 for all a≧ã.
Product reliability: in each month of the product lifetime, it is subject to failure or an event that will require a repair (i.e., a failure of some type that renders the product nonfunctional). It is assumed that at most one failure can occur in any particular period, and a product of age a periods experiences failure with a probability of “fₐ” in any given period. Failure probability, like product utility, depends only on the product age and not on the period in which the failure occurs. Moreover, we make the assumption that the failure probability is independent of failure history.
Repair costs: “Cₐ” denotes the random, out-of-warranty, repair cost to the customer for failures that occur in a given period when the product is of age a periods. And the function “Gₐ(c)” is the cumulative distribution function of Cₐ. For a failure that costs the customer “c” to repair out-of-warranty, we assume that the repair cost borne by the service provider is some fraction of the repair cost or βc, where 0≦β≦1.
Replacement cost to the customer: replacing a product costs the customer “q” dollars. And if θ, where 0≦θ≦1, represents the cost to the service provider to supply a product replacement, the provider earns a margin of (1−θ)q on each replacement provided to the customer. If the service provider does not supply any replacement hardware to the customer, he earns no margin on replacements and thus effectively θ=1 in this case. Note also that in our model the replacement cost q could include installation costs, or some kind of “inconvenience costs” to the customer.
Salvage value: “sₐ” is defined to be the customer's end-of-horizon salvage value for a functional product of age a.
Discount factor: “α” is defined to be the discount factor that applies to future cash flows for both the customer and the service provider. A discount factor of a means that in any given period, the customer and the provider are indifferent between earning $αd dollars today or $d dollars in the next period.
Customer risk attitude: in this model the customer is assumed to be risk neutral.
Cost of coverage in each period: at the beginning of each period, the customer has an option to buy coverage at a cost of “pₐ” for a product of age a.
Refund: in one aspect of the present invention we introduce the possibility of providing the customer a refund “r” where r≦pₐ on a periodic warranty premium paid to the customer if the customer makes no claim against the warranty in the period in which coverage was purchased.

One aspect of the invention consider a general monthly EW that offers complete coverage flexibility to the customer in terms of his ability to turn coverage on and off whenever desired. This flexibility makes the warranty more attractive to most customers than a traditional, fixed-term EW, especially for those individuals with financial constraints. In the context of this monthly warranty example, the “period” is defined to he a month. One could similarly define a quarterly warranty in which the period represents a quarter of a year.

The Customer's Strategy

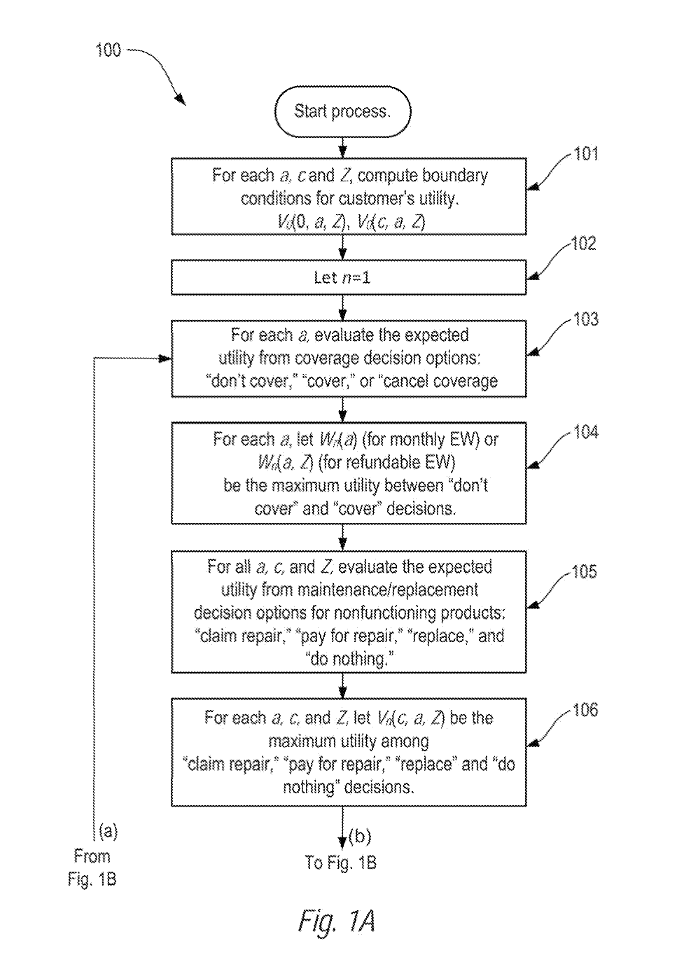

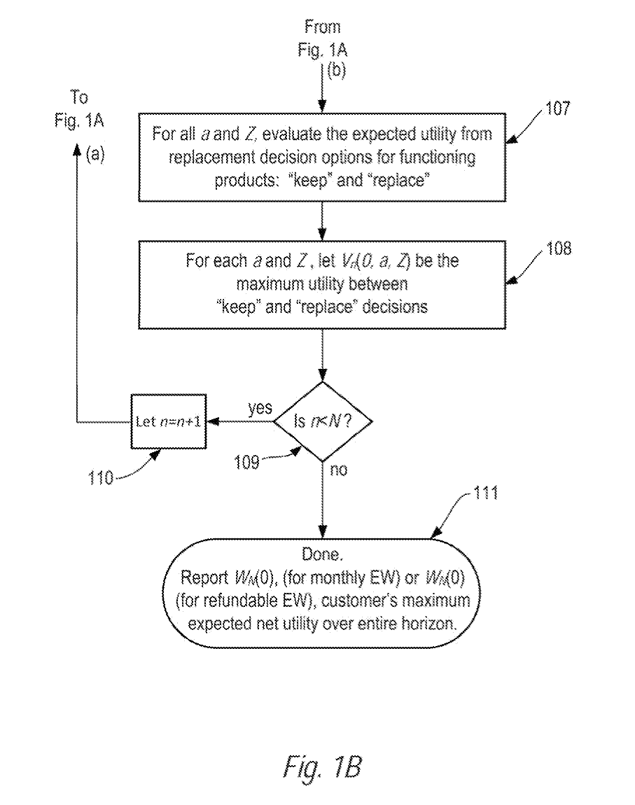

FIGS. 1A and 1B depict a single flowchart which summarizes the technique 100 for determining a customer's optimal dynamic decisions to maximize the expected discounted net utility when choosing a product replacement versus warranty coverage in accordance with a representative embodiment of the present invention.

The customer's economic analysis is in deciding which months to buy coverage for and when to repair or replace the product, in order to maximize the expected discounted value from the product, net of costs for repair, coverage and product replacement. The customer in this model is allowed to turn on and off coverage at any time, although in other embodiments of our invention, restrictions can be imposed on when coverage can be purchased. We formulate the customer's optimal maintenance and coverage decisions as a dynamic program. Dynamic programming is a method of breaking down large complex decision problems into a set of simpler subproblems. For example a problem that involves determining the best decisions over several time periods can be broken down into sub-problems that involve determining the decision in each individual time period, while considering the impact of the decision on the current period as well as on subsequent periods. Such is the case in our application of dynamic programming to finding a customer's optimal decisions over a time horizon, and maximum expected discounted value over that horizon. We break the problem down into subproblems, each of which involves determining decisions for a single time period. The dynamic program considers the impact of current-period decisions on current and future value to the customer.

The description of a dynamic program includes its state, which summarizes all relevant information about the system (i.e., the status of the product) as it evolves. The state may have multiple variables in its description. In the dynamic program describing customer's optimal product replacement and monthly EW purchase decisions, we let c represent a state variable denoting the known repair costs a customer faces for a failure that occurred in the previous month. Where c=0 the customer had no failure in the previous month, and c>0 indicates that a failure occurred in the previous month or some other preceding month where no action was taken. A second state variable is the product's age a as defined above. We also let the variable Z indicate whether the customer had warranty coverage for failures that may or may not have occurred in the previous month(s).

If Z=1, this indicates that the preceding month's failures were covered, and if Z=0, this indicates that they were not covered.

When the repair cost c>0, the customer must choose to either repair the product (at cost c, if the product was not covered by a warranty, i.e., uncovered, or at a co-payment cost of h(c) if the product was covered by a warranty), replace the product with a new one at price q, or stop using the product and not buy a replacement—thereafter earning zero product utility and incurring no costs. We prohibit the customer from turning on the coverage after the occurrence of a failure without first restoring the product to a functional state. If c=0, the product is in a functional state, and the customer may choose to keep it or replace it, i.e., no repair is necessary. At the beginning of each month, the customer has an option to buy coverage for the month at cost pₐ for a product of age a.

It is also possible to generalize the model to introduce the concept of a refund r≦pₐ on the monthly warranty premium that is paid to the customer if no claim is made against the warranty in the month in which coverage was purchased. An important special case is when r=0. However, allowing a more general r enables us to model a broader range of services, including a contingent service, within the same framework.

We let state S=(c, a, Z) denote the state of the product in each month, where

c=the cost of a repair for a failure (if any) that occurred in the previous month,

a=the age of the product, and

Z=the coverage status in the preceding month.

We count time backward, i.e., n is the remaining number of months to go in the horizon. And let

Vₙ(S)=customer's maximum expected discounted value over the next n months before making replacement decision, starting in state S=(c, a, Z). And,

Wₙ(a)=customer's maximum expected discounted value over the next n months after making replacement decision, starting with a functional (i.e., working) product of age a.

In the dynamic program, the customer determines his optimal decisions in a given month by considering the impact of decisions in the current month as well as the future impact of the decisions. The customer's decisions in each month are characterized by the following dynamic equations:

Keep or Replace Decision:

Vₙ(c, a, Z)=max{Wₙ(a)−cI_{z=0}−h(c)I_{z=1}, Wₙ(a)−c+rI_{z=1}, Wₙ(0)−q+rI_{z=1}, rI_{z=1}+αVₙ₋₁(c, a+1,0)}, for c>0 (1)

reflecting the customer's choices between making a claim for a failed product (if it is covered), repairing at his own expense, replacing the product, or doing nothing, and,

Vₙ(0, a, Z)=max{Wₙ(a)+rI_{z=1}, Wₙ(0)−q+rI_{z=1}} (2)

where I_{z=k} is an indicator variable equal to 0 or 1(1 if Z=k and otherwise 0). This equation reflects the customer's decision between keeping a functional product or replacing it.

Coverage Decision:

Wₙ(a)=uₐ+max{α[(1−fₐ)Vₙ₋₁(0, a+1,1)+fₐE_{Ca}[Vₙ₋₁(Cₐ, a+1,1)]]−pₐ, α[(1−fₐ)Vₙ₋₁(0, a+1,0)+fₐE_{Ca}[Vₙ₋₁(Cₐ, a+1,0)]]}, (3)
where E_{Ca}[Vₙ₋₁(·)] is the expectation of Vₙ₋₁(·) with respect to Cₐ. This equation reflects the customer's choice between purchasing or not purchasing coverage in the current month.

Without loss of generality, suppose the boundary conditions describing the customer's expected discounted net utility with zero periods remaining are as follows:

W₀(a)=sₐ.

V₀(0, a, Z)=sₐ+rI_{Z=1}, and

V₀(c, a, Z)=max(sₐ−h(c)I_{Z=1}−cI_{Z=0}, rI_{Z=1}) for c>0.

The customer's maximum expected discounted value over an N-month horizon, starting with a new product, is W_{N}(0).

One can observe that in each of equations (1), (2) and (3), the customer makes a decision based on the current state of the system, including the product failure status, its age, and (in the case of replacement decisions) its coverage status. Different states may result in different decisions. Moreover, the replacement or coverage decision in each state and period is selected to be the one that yields the maximum expected discounted net utility, including utility earned in the current period plus the expected discounted utility from future periods resulting from these decisions. Because of the dependency of current decisions on future expected discounted utility, the value functions with n periods remaining in the horizon, Vₙ(S) and Wₙ(a), cannot he computed until the value functions Vₙ₋₁(S) and Wₙ₋₁(a) are known. Thus, the customer's value functions must be computed recursively starting from n=0. After computing Vₙ(S) and Wₙ(a) for n=0, the customer then computes the same value functions for n=1, and then n=2, etc, and is finished when he computes the value functions for n=N.

FIGS. 1A and 1B depict a single flowchart which summarizes the technique 100 for determining a customer's optimal dynamic decisions to maximize the expected discounted net utility when making product replacement decisions and warranty coverage decisions in accordance with a representative embodiment of the present invention. The process begins in step 101 where we initially compute the boundary conditions for the utility functions V₀(0, a, Z) and V₀(c, a, Z) for the case when n=0. Then at step 102 the same utility functions are computed for n=1. Subsequently we begin the series of steps 103 through 109 that will apply to each value of n≧0. In step 103, we consider every possible age a that the product could have. (Note that a can take values only in the set {0, 1, . . . , N−n} if we begin the horizon with a new product, since only N−n periods have elapsed.) For each such age, we evaluate the total expected discounted net utility that would ensue from each of the decisions to purchase coverage for the product (“cover”) or not purchase coverage for the product (“don't cover”). After doing so at step 104 for each age a, we compare the utilities from these two decisions, determine which decision yields the higher utility, and let Wₙ(a) be the maximum utility from the better of the two decisions, as in equation (3). We then proceed to step 105 in which we consider the product maintenance and replacement decision options for a failed product. For each possible value of the system state for a failed product (repair cost c>0, product age a, and coverage status Z), we compute the expected discounted net utility from each of the decisions “claim repair,” “pay for repair,” “replace,” and “do nothing.” We then continue to step 106 and for each possible value of the system state, we compare the utilities from these four decisions, determine which decision yields the highest utility, and let Vₙ(c,a, Z) be the maximum utility from the best of the four decisions, as in equation (1). Then at step 107 we consider the replacement decision for a functional product. In this step for each possible value of the system state in which the product is functional (i.e., the repair cost c=0. product age a, and coverage status Z), we compute the expected discounted net utility from each of the decisions “keep” and “replace.” At step 108 for each value of the system state, we compare the utilities from these two decisions, determine which decision yields the higher utility, and let Vₙ(0, a, Z) be the maximum utility from the better decision, as in equation (2). At this point we have completed the computations for n=1. We proceed next to step 109 where we cheek whether n<N. If n<N, then we increment n by 1 in step 110 and go back to step 103 and perform steps 103 through 109 again for this next value of n. We continue performing steps 103 through 110 for successive values of n until we have completed steps 103-109 for n=N. If n=N, we branch to step 111 and report the expected discounted net utility W_{N}(0) which represents the maximum expected discounted net utility over the entire N-period horizon starting with a new (a=0) product.

Note that there may be a very large number of possible values of the state, and as such, steps 105-108 are very computationally intensive.

We are not implying that any actual customer will exhibit such a strategy to optimize his economic decisions, particularly since the customer may not have all the various parameters available to him (such as the failure rates of a product or the likely repair costs), and since this approach is computationally intensive and therefore may be impractical to implement in one's head. But if all the parameters were known then the rational customer could make these decisions to maximize his expected discounted net utility. Thus technique 100 for determining a customer's optimal dynamic decisions is an important step to have available, since it has an impact on the profitability of the OEM/service provider as shown below. (Because this process is very computationally intensive and because the typical individual customer does not usually have all the various parameters available in making the decisions to maximize his expected discounted net utility, the service discussed below is another aspect of this invention that can provide very useful information to a customer not otherwise available.)

The preceding model is quite general in that it allows for copayments and refunds of warranty premia based on claim behavior of the customer. Important special cases of the monthly warranty which can be implemented into our computerized tool include:

Basic Monthly EW. In the most basic monthly EW, the customer is not charged copayments [h(c)=0 for all c] and is given no refund regardless of claim history (r=0).

Monthly EW with Copay. A monthly copayment EW charges the customer a fixed copayment for repairs [h(c)=h for all c] and gives no refund regardless of claim history (r=0). The copayment may be the costs to ship the item to and from the repair facility, for example.

Contingent Service. Now consider a monthly warranty for which the full monthly premium is refunded to a customer who made no claims against the warranty (r=pₐ). Moreover, suppose that if the customer chooses to repair a product under warranty, he is charged a copayment equal to the warranty provider's repair costs. Then the copayment is h(c)=βc for a repair that would cost the customer (c) out-of-warranty. We call such a warranty a contingent service.

Service Provider's Profits

Obviously the strategic economic behavior of customers has an impact on the profitability of the OEM/service provider. By properly modeling the service provider's profits, it is possible to consider the important question of how to design and price a monthly warranty. The notation used below to describe the service provider's profit is as follows.

VΠₙ(c., a, Z)=service provider's total expected discounted profit from a customer starting in state (c, a, Z) with n months to go, before the customer's replacement decision; and,

WΠₙ(a)=service provider's total expected discounted profit from a customer starting with a functional product of age a with n months to go, after the customer's replacement decision has been made.

The service provider's profits in each month are characterized by the following dynamic equations:

Keep or replace decision (for nonfunctional, products covered by an EW):
if Wₙ(a)−h(c)≧max(Wₙ(a)−c+r, Wₙ(0)−q+r, r+aVₙ₋₁(c, a+1, 0)),

VΠₙ(c, a, 1)=h(c)−βc+WΠₙ(a). (4)
if Wₙ(a)−c+r≧max(Wₙ(a)−h(c). Wₙ(0)−q+r, r+αVₙ₋₁(c, a+1, 0)),

VΠₙ(c, a, 1)=−r+WΠₙ(a), (5)
if Wₙ(0)−q+r≧max(Wₙ(a)−h(c), Wₙ(a)−c+r, r+αVₙ₋₁(c, a+1, 0)),

VΠₙ(c, a, 1)=(1−θ)q−r+WΠₙ(0), (6)
if r+αVₙ₋₁(c, a+1,0)≧max(Wₙ(a)−h(c), Wₙ(a)−c+r, Wₙ(0)−q+r),

VΠₙ(c, a 1)=−r+αVΠₙ₋₁(c, a, 1, 0). (7)

Keep or replace decision (for nonfunctional products not covered by an EW):
if Wₙ(a)−c≧max(Wₙ(0)−q, αVₙ₋₁(c, a+1, 0)), then the customer prefers to replace the product, and

V∪ₙ(c, a, 0)=WΠₙ(a) (8)
if Wₙ(0)−q≧max(Wₙ(a)−c, αVₙ₋₁(c, a+1, 0)), then the customer prefers to replace the product, and

VΠₙ(c, a, 0)=(1−θ)q+WΠₙ(0) (9)
if a Vₙ₋₁(c, a+1,0)≧max(Wₙ(a)−c, Wₙ(0)−q), then the customer prefers to do nothing with the product, and

VΠₙ(c, a, 0)=αVΠₙ₋₁(c, a+1,0). (10)

And the keep or replace decision (for functional products) is:
if Wₙ(0)−q≧Wₙ(a), then the customer prefers to replace the product, and

VΠₙ(0, a, Z)=(1−θ)q−rI_{z=1}+WΠₙ(0), (11)
If Wₙ(a)≧Wₙ(0)−q, then the customer prefers to keep the product as is, and

VΠₙ(0, a, Z)=WΠₙ(a)−rI_{z=1}, (12)

If Wₙ(a)≧Wₙ(0)−q, then the customer would prefer to continue with a product of age a (earning expected discounted utility Wₙ(a)) than to pay q to replace the product and continue with a new (age 0) product (earning an expected discounted utility of Wₙ(0)−q). Then the decision for the customer whether to purchase coverage or not purchase it in this period is as follows:

if α((1−fₐ)Vₙ₋₁(0, a+1,1)+fₐE_{Ca}[Vₙ₋₁(Cₐ, a+1,1)]−pₐ≧α((1−fₐ)Vₙ₋₁(0, a+1,0)+fₐE_{Ca}[Vₙ₋₁(Cₐ, a+1,0)]),

then the customer prefers to purchase EW coverage in this period, and

WΠₙ(a)=pₐ+α(1−fₐ)VΠₙ₋₁(0, a+1,1)+fₐE_{Ca}[VΠₙ₋₁(Cₐ, a+1,1)]), (13)

Otherwise, the customer prefers not to purchase EW coverage, and:

WΠₙ(a)=α((1−fₐ)VΠₙ₋₁(0, a+1,0)+fₐE_{Ca}[VΠₙ₋₁(Cₐ, a+1,0)]). (14)

The boundary conditions are:

WΠ₀(a)=0,

VΠ₀(0, a, Z)=−rI_{z=1}, and

VΠ₀(c, a, Z)=0 for c>0.

While the provider's total expected discounted profit from a new, hardware customer over an N-period horizon is WΠ_{N}(0).

One can observe that in equations (4)-(14), the profit functions with n periods remaining in the horizon, VΠₙ(S) and WΠₙ(a), cannot be computed until the profit functions VΠₙ₋₁(S) and WΠₙ₋₁(a) are known. Thus, the provider's profit functions must be computed recursively starting from n=0. After computing VΠₙ(S) and WΠₙ(a) for n=0, the provider then computes the same value functions for n=1, then n=2, etc, and is finished when he computes the value functions for n=N.

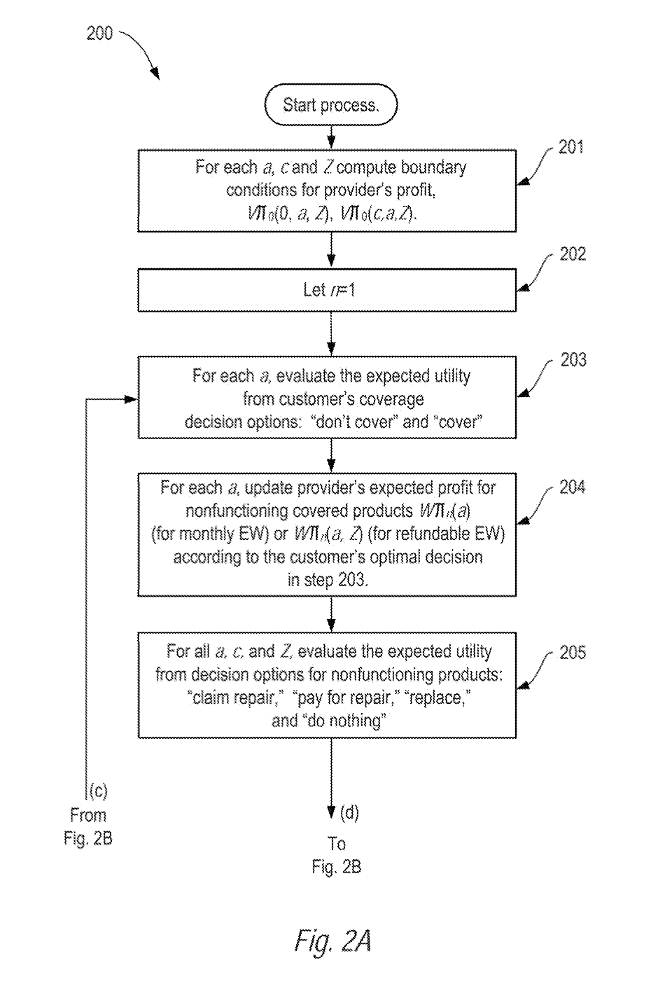

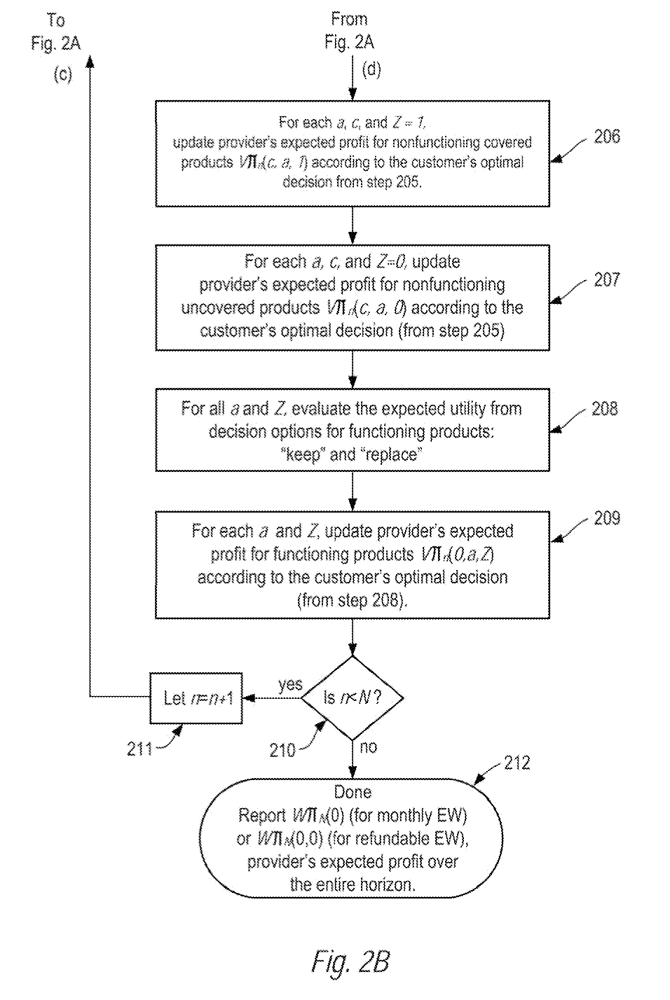

FIGS. 2A and 2B depict a single flowchart which summarizes the technique 200 for determining the service provider's expected discounted profit from hardware replacements, EW sales, and out-of-warranty repairs from a customer who is making product replacement decisions and warranty coverage decisions to maximize his expected discounted net utility, in accordance with a representative embodiment of the present invention. The process begins at step 201 where we compute the boundary conditions for the provider's expected discounted profit functions VΠ₀(0, a, Z) and VΠ₀(c, a, Z), representing the case when n=0. Then at step 202 we let n=1, and begin the series of steps 203 through 210 that will apply to each value of n≧0. In step 203 (which note, is the equivalent of step 103—this step is common to both processes), we consider every possible age a that the product could have. For each such age, we evaluate the customer's expected discounted net utility that would ensue from each of the customer's decisions to purchase coverage for the product (“cover”) or not purchase coverage for the product (“don't cover”). After doing so, at step 204 and for each age a, we update the provider's profit WΠₙ(a) according to the better of the customer's two decisions, as in equations (13)-(14). We then proceed to step 205 (which is the equivalent of step 105) in which we consider the customer's product maintenance and replacement decision options for a failed product. For each possible value of the system state for a failed product (repair cost c>0, product age a, and coverage status Z) we compute the customer's expected discounted net utility from each of the decisions “claim repair,” “pay for repair,” “replace,” and “do nothing.” Then at step 206 and for each possible value of the system state with Z=0, we update the provider's expected discounted profit VΠₙ(c, a, 0) according to the best decision for the customer, as in equations (4)-(7). Then at step 207 for each possible value of the system state with Z=1. we update the provider's expected discounted profit VΠₙ(c, a, 1) according to the best decision for the customer, as in equations (8)-(10).

We then proceed to step 208 in FIG. 2B (which is equivalent to step 107), where for each value of the system state for a functioning product, we evaluate the customer's expected discounted utility from each of the decisions “keep” and “replace.” At step 209 for each value of the system state for a functional product, we update the provider's expected discounted profit VΠₙ(0, a, Z) according to the best decision for the customer as in equations (11)-(12).

At this point we have completed the required computations for n=1. We proceed to step 210 where we check whether n<N. If n<N, then we increment n by 1 at step 211 and go back to step 203 to perform steps 203 through 211 again for the incremented value of n. We repeat steps 203 through 211 for successive values of n until we have completed steps 203-210 for n=N. If n=N, we branch to step 212 and report the expected discounted net utility WΠ_{N}(0) which represents the provider's total expected discounted profit from the customer over the entire N-period horizon when the customer starts with a new (a=0) product.

A second important element of the monthly warranty invention is that we have specified a method to compute the provider's expected discounted profit over the horizon from the perspective of a strategic customer who is offered a monthly warranty, through the equations described above. This is another building block for the methodology to design and more importantly price profitable warranties:

Refundable EWs

It is possible to extend this methodology to a traditional EW that may or may not be refundable, i.e., provide a refund to a customer, whether in the form of a cash rebate or as a credit on future product, upon termination of the EW coverage. We assume that this EW must be purchased when the covered product is new, that is when a=0. If we let p denote the price of the EW, and d denote the coverage duration of the EW, the EW, if purchased, covers failures that occur in months with product age a=0, 1, 2, . . . , (d−1). As in the previous section, state S=(c, a Z) denotes the state of the product before the repair/replacement decision is made in a given month, where c indicates the cost of repair of a failure (if any) that occurred in the preceding month, a indicates the product age, and Z indicates the coverage status for failures that occurred in the preceding month.

To simplify the dynamic programming equations, let Z′(a) denote the coverage status for failures during a month for a product of age a that had an EW purchased when the product was new. Thus,

Z′(a)=1 for a<d and

Z′(a)=0 if a≧d.

When the customer makes a claim for failure within the warranty coverage period (i.e., a<d), the customer then makes a co-payment of h(c) which is less than what an out-of-warranty repair cost c would be. To generalize a refund from the monthly EW so as to be age-dependent: let r(a) denote the refund for an EW that is canceled when the product is age a, 0≦a≦d−1. This age dependent refund schedule allows for a pro-rated refund structure. Then

Vₙ(S)=the maximum expected discounted value over the next n months before making

a replacement decision, starting in state S=(c, a, Z), and

Wₙ(a, Z)=the maximum expected discounted value over the next n months after making a
replacement decision, starting with a functional product of age a and coverage status Z.

The customer's decisions in each month are characterized by the following dynamic equations:

Keep or replace decision:

Vₙ(c, a, 0)=max{Wₙ(a, 0)−c, Wₙ(0, 0)−q, αVₙ₋₁(c, a+1, 0)}, c>0, a≧1 (15)

Vₙ(c, a, 1)=max{Wₙ(a, Z′(a))−h(c)+r(a)I_{a=d}, Wₙ(0,0)−q+r(a), rI_{a=d}+αVₙ₋₁(c, a+1, Z′(a))}, for c>0, and 1≦a≦d, (16)

Vₙ(0, a, 0)=max{Wₙ(a, 0),Wₙ(0, 0)−q}, (17)

Vₙ(0, a, 1)=max{Wₙ(a, Z′(a))+rI_{a=d}, Wₙ(0, 0)−q+r(a)}, for 1≦a≦d. (18)

Equation (15) characterizes the customer's economic decisions when the product is not functioning and when the failure occurred without warrant coverage. At that juncture the customer must decide whether to repair, replace, or do nothing with the broken product.

Equation (16) characterizes a customer's economic decisions about a non-functioning product whose failure was covered under a warranty. The customer again must decide whether to repair it (i.e., make a claim), replace it, or do nothing with the broken/nonfunctioning product.

Equation (17) characterizes the customer's economic choices for a functioning uncovered product: to keep or to replace it.

And equation (18) describes the same economic choices for a functioning covered product: to keep or to replace it.

Now we address the customer's EW coverage choices.

Wₙ(0, 0)=uₐ+max{α((1−f₀)Vₙ₋₁(0, 1, 1)+f₀E_{C0}[Vₙ₋₁(C₀, 1, 1)])−p, α((1−f₀)Vₙ₋₁(0, 1, 0)+f₀E_{C0}[Vₙ₋₁(C₀, 1, 0)])}, (19)

Wₙ(a, 0)=uₐ+α((1−fₐ)Vₙ₋₁(0, a+1, 0)+fₐE_{Ca}[Vₙ₋₁(Cₐ, a+1, 0)]), a≧1 (20)

Wₙ(a, 1)=uₐ+max{α((1−fₐ)Vₙ₋₁(0, a+1,1)+fₐE_{Ca}[Vₙ₋₁(Cₐ, a+1, 1)]), r(a)+α((1−fₐ)Vₙ₋₁(0, a+1, 0)+fₐE_{Ca}[Vₙ₋₁(Cₐ, a+1, 0)]} (21)
where 1≦a≦(d−1).

Equation (19) characterizes the customer's choice for purchasing or not purchasing a warranty for a new product. The second equation (20) describes the customer's expected discounted utility for a non-new, uncovered product. The customer has no decision to make in this case. He can nether purchase coverage, nor cancel coverage, since warranty coverage in one embodiment of this invention must be started when the product is new if at all. In another embodiment it is possible to permit a customer to turn EW coverage on or off, but then it is necessary to introduce an activation fee charged when coverage is reactivated. (Obviously there are additional costs incurred by the service provider to verify that the product is operational when coverage is turned back on. Note that this is discussed below.) Equation (21) reflects the customer's choices for a non-new product with coverage: whether to continue coverage or cancel it.

Without loss of generality, suppose that the boundary conditions are as follows:

Wₙ(a, Z)=sₐ+r(a)I_{Z=1},

V₀(0, a, Z)=sₐ+r(a)I_{Z=1} and

V₀(c, a, Z)=max(sₐ+r(a)I_{Z=1}−cI_{Z=0}, r(a)I_{Z=1}) for c>0.

The customer's maximum expected discounted utility over an N-period horizon, starting with a new product, is W_{N}(0,0).

An important part of the flexible or refundable warranty invention is the specification of a method to compute the customer's maximum total expected discounted net utility from a refundable warranty over the horizon, through the dynamic programming equations specified above. This is one of the building blocks for the methodology to design and price profitable warranties. Like the monthly or periodic invention, this model reflects the customer's ability to dynamically make maintenance and replacement decisions as failures occur, unlike prior art approaches. There are, however, special cases of an EW worth mentioning including:
The tradition, non-refundable EW: here the customer is not charged copayments (h(c)=0 for all c) and is given no refund upon cancellation (r(a)=0 for all a).
The non-refundable EW with copayments: another type of EW that can be modeled within this framework is one with a fixed copayment {h(c)=h for all c} and no refund provided upon cancellation {r(a)=0 for all a}. The copayment could simply be the shipping costs borne by the customer.
The refundable EW with a pro-rated refund: a simple type of refundable warranty is one with no copayments {h(c)=0 for all c} and refunds that are pro-rated based on how much of the warranty term has expired {r(a)=p(1−a/d)}.
Out-of-warranty repair services: in this case, there is no upfront price of the service (p=0), the copayment is equal to the out of warranty repair cost {h(c)=c} and there is no refund, i.e., r(a)=0 for all a.

Service Provider's Profits

The service provider's expected discounted profits under the refundable EW can be expressed in a similar manner. Using the same notation as in the case of a monthly EW:
VΠₙ(c, a, Z)=service provider's total expected discounted profit from a customer starting in state (c, a, Z) with n months or periods to go, before the customer's replacement decision; and,
WΠₙ(a, Z)=service provider's total expected discounted profit from a customer starting with a functional product of age a and with a warranty status of Z with n months or periods to go, after the customer's replacement decision has been made.

There are four situations to consider in assessing the service provider's profit: nonfunctioning, covered products, i.e., (1≦a≦d, c>0), nonfunctioning uncovered products (c>0), functioning, covered products (1≦a≦d), and functioning uncovered products. For nonfunctioning, covered products the keep-or-replace decision is as follows.
If Wₙ(a, Z′(a))−h(c)+r(a)I_{a=d}≧max{Wₙ(0, 0)−q+r(a), r(a)I_{a=d}+αVₙ₋₁(c, a+1, Z′(a))}, the customer prefers to make a claim, and

VΠₙ(c, a, 1)=h(c)−βc−r(a)I_{a=d}+Wₙ(a, Z′(a)). (22)
If Wₙ(0, 0)−q+r(a)≧max{Wₙ(a, Z′(a))−h(c)+r(a)I_{a=d}, r(a)I_{a=d}+αVₙ₋₁(c, a+1, Z′(a))}, the customer prefers to replace the product, and

VΠₙ(c, a, 1)=(1−θ)q−r(a)+WΠₙ(0), (23)
If r(a)I_{a=d}+αVₙ₋₁(C, a+1, Z′(a))≧max{Wₙ(a, Z′(a))−h(c)+r(a)I_{a=d}, Wₙ(0,0)−q+r(a)},
   the customer prefers to take no action with the product in the month in question and

VΠₙ(c, a, 1)=−r(a)I_{a=d}+αVΠₙ₋₁(c, a+1, Z′(a)). (24)

For nonfunctioning, uncovered products (c>0), the keep or replace decision is as follows.

if Wₙ(a, 0)−c≧max{Wₙ(0, 0)−q, αVₙ₋₁(c, a+1, 0)}, the customer prefers to repair the product, and

VΠₙ(c, a, 0)=WΠₙ(a, 0) (25)

if Wₙ(0, 0)−q≧max{Wₙ(a, 0)−c, αVₙ₋₁(c, a+1, 0)}, the customer prefers to replace the product, and

VΠₙ(c, a, 0)=(1−θ)q+WΠₙ(0,0), (26)

if αVₙ₋₁(c, a+1,0)≧max{Wₙ(a, 0)−c, Wₙ(0,0)−q},

the customer prefers to take no action in the month in question, and

VΠₙ(c, a, 0)=αVΠₙ₋₁(c, a+1,0). (27)

For functioning, covered products (1≦a≦d), the keep or replace decision is as follows.

If Wₙ(a, Z′(a))+r(a)I_{a=d}≧Wₙ(0,0)−q+r(a),

the customer prefers to keep the product, and

VΠₙ(0, a, 1)=−r(a)I_{a=d}+WΠₙ(a, Z′(a)), (28)

if Wₙ(0,0)−q+r(a)>WΠₙ(a, Z′(a))+r(a)I_{a=d},

the customer prefers to replace the product, and

VΠₙ(0, a, 1)=(1−θ)q−r(a)+WΠₙ(0, 0). (29)

Then for functioning, uncovered products:

if Wₙ(a, 0)≧Wₙ(0, 0)−q,

the customer prefers to keep the product, and

VΠₙ(0, a, 0)=WΠₙ(a, 0), (30)

if Wₙ(0,0)−q>Wₙ(a, 0), the customer prefers to replace the product, and

VΠₙ(0, a, 0)=(1−θ)q+WΠₙ(0, 0). (31)

The customer's decision to obtain warranty coverage is as follows:

for new products (i.e., where a=0),
if α((1−f₀)Vₙ₋₁(0, 1, 1)+f₀E_{C0}[Vₙ₋₁(C₀, 1, 1)])−p≧α((1−f₀)Vₙ₋₁(0, 1, 0)+f₀E_{C0}[Vₙ₋₁(C₀, 1, 0)]),
   then the customer prefers to purchase coverage, and

WΠₙ(0,0)=p+α((1−f₀)VΠₙ₋₁(0, 1, 1)+f₀E_{C0}[VΠₙ₋₁(C₀, 1, 1)]). (32)

Otherwise, the customer prefers not to purchase coverage, and

WΠₙ(0,0)=((1−f₀)VΠₙ₋₁₍0, 1, 0)+f₀E_{C0}[VΠₙ₋₁(C₀, 1, 0)]). (33)

For products that are not covered by a warranty and that are not new (i.e., where a≧1); the customer has no decision to make since:

WΠₙ(a, 0)=α((1−fₐ)VΠₙ₋₁(0, a+1,0)+fₐE_{Ca}[VΠₙ₋₁(Cₐ, a+1,0)]). (34)

But for products covered by a warranty (where 1≦a≦(d−1)):
if α((1−fₐ)Vₙ₋₁(0,a+1,1)+fₐE_{Ca}[Vₙ₋₁(Cₐ, a+1,0)])≧r(a)+α((1−fₐ)Vₙ₋₁(0, a+1, 0)+fₐE_{Ca}[Vₙ₋₁(Cₐ, a+1,0)]), the customer prefers to continue the warranty coverage, and

WΠₙ(a, 1)=α((1−fₐ)VΠₙ₋₁(0, a+1,1)+fₐE_{Ca}[VΠₙ₋₁(Cₐ, a+1,1)]). (35)

Otherwise, the customer prefers to cancel the warranty coverage, and

WΠₙ(a, 1)=−r(a)+α((1−fₐ)VΠₙ₋₁(0, a+1,0)+fₐE_{Ca}[VΠₙ₋₁(Cₐ, a+1,0)]). (36)

The service provider's total expected discounted profit from a new hardware customer over an N-period horizon is WΠ_{N}(0, 0). This represents the maximum total expected discounted utility over the entire horizon, starting with a new product (assuming that optimal decisions are followed throughout the horizon.

Another important element of the refundable warranty invention is a method to compute the provider's expected discounted profit over the horizon from a strategic customer who is offered a refundable warranty, through the equations described above.

There are several ways in which the preceding models for monthly and refundable EW can be further generalized. Each of these generalizations is potentially valuable from a commercial perspective, and so we believe they are all important aspects of the invention.

Restrictions on monthly warranty coverage: The preceding discussion of the monthly EW allowed customers to turn coverage on and off whenever they liked. One could easily introduce restrictions on when coverage could be purchased. For example, we could impose a requirement that coverage must be started in the first month (or few months) of the product life. We could also limit the product age at which one could purchase coverage for a product to limit the provider's exposure to high failure costs for very old products. These ideas can be implemented as restrictions, or instead implemented monetarily through payments of activation fees or high monthly premia for products beyond some predetermined age.

Competition for hardware replacements: Consider the case in which the service provider is also a manufacturer of the product in question. When a customer decides to replace the hardware product, he chooses to replace with hardware from the same manufacturer with probability “ρ.” If he chooses a different hardware brand, then the manufacturer will lose the future profits from this customer. (We assume there are one or more competing hardware providers in the marketplace.) The customer can choose any of these other hardware providers and can expect the same future costs as would be incurred if the original provider were selected.

Competition for out-of-warranty repair services: each time a customer chooses to repair a product out of warranty, we assume that the customer chooses the original manufacturer to provide this service with probability “ω” and an alternative service provider having the same repair prices with probability (1−ω).

Restricted-use refunds: rather than paying cash refunds, a manufacturer/provider may choose to pay refunds in the form of a credit toward the purchase of new hardware from the same provider. In this case, the provider only needs to pay the refund if the customer buys a replacement product from the same provider. The customer places less value on the refundability of the EW when the refund is issued as a hardware credit, because the refund only materializes with probability ρ. However, credit-type refunds may increase his repurchase probability for this brand as compared to cash refunds. These effects can be captured in the model.

Claim-dependent refunds on refundable EW. We can also generalize the refundable EW to make the refund schedule dependent on the number of claims made against the warranty. This requires a state space expansion to include one additional state variable, the number of claims made so far against the warranty. Note that such state space expansion will slow down the solution of the customer dynamic programming and computation of provider profits. This generalization allows us to model residual value EWs and in particular, risk-free EWs, i.e., where the entire price of the EW is refunded to customers who have no claims during the coverage period.

Activation fees for monthly EW: a hardware provider may want to charge an activation fee for a monthly EW that is dependent upon the age of the product when the warranty is first purchased after one or more months without coverage. An activation fee can cover the costs of verifying that the product is functioning when coverage begins. Making the activation fee age-dependent can help to remove the adverse selection problem arising from customers wishing to insure only old, failure-prone products. Adding this feature to the EW model requires the addition of a state variable indicating whether the product was under warranty in the previous period.

Information asymmetry in product reliability and repair cost distribution: the customer may not know the true failure probabilities or failure cost distribution. A customer may base maintenance, replacement and coverage decisions on an incorrect belief about these distributions, whereas the provider profits are based on accurate product reliability information.

Breakdown of costs and profits: when computing the provider's expected discounted profits, one could easily determine how these profits decompose into profits from hardware replacements, out-of-warranty repair, and EW sales. This decomposition can be instructive because the results illustrate, in aggregate, the choices customers are making when offered the service, without having to examine the choices made for every element of the state space. Similarly, when computing expected discounted customer utility, one can also compute the customer's expected discounted costs from replacements, services and out-of-warranty repairs.

To facilitate a better understanding of our methodology of evaluating flexible EWs, consider the following typical application of one aspect of an embodiment of our invention. The numerical data used in the example below was chosen to be representative of an inexpensive personal computing product, such as a netbook, for which a monthly EW may be more appealing than a traditional, fixed-term EW.

The horizon length is T=24 months.

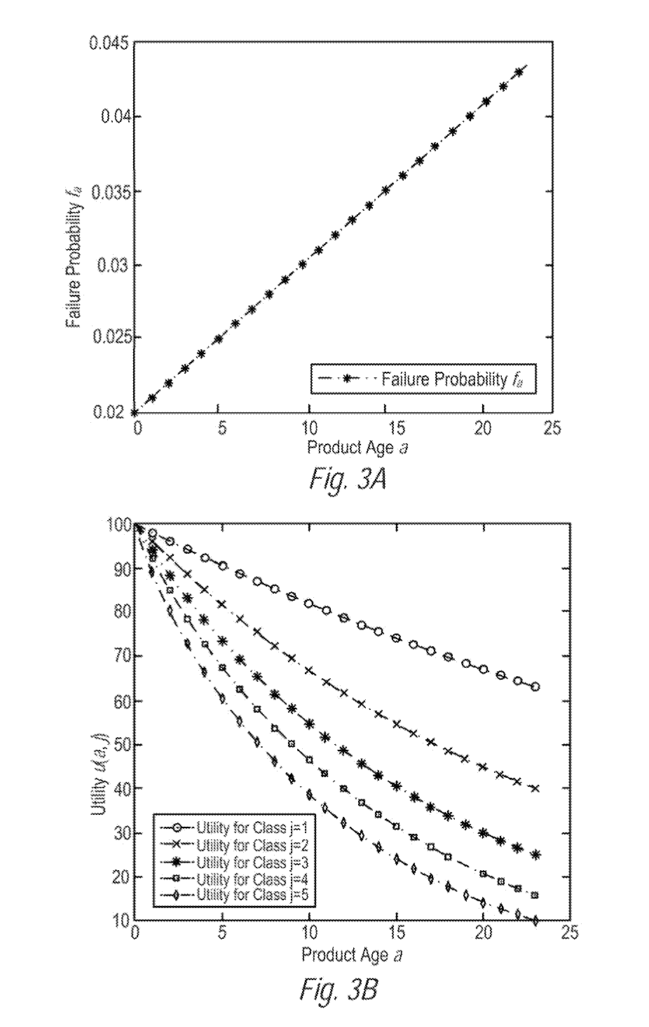

We assume a linear increase in failure probabilities over a product's life as depicted in the graph shown in FIG. 3A. The failure probability in a month where the product's age a is fₐ=(0.02+0.001a). Products that are subject to some wear-and-tear do increase in their failure probability over time. But a linear increase is a reasonable approximation of the growth in failure probability for a PC.

Customers are assumed to be heterogeneous in their utility schedule. In this example there are five customer classes. Customer class j has utility schedule given by u(a,j)=100e^{-0.02ja}. Thus each customer starts with the same utility of $100 in the first month, but the utility increasingly decays over time for the higher customer class indices. The utility schedules for each customer type are shown in FIG. 3B. In this example, customer type 5 is representative of someone who really likes to own the newest technology (he could be characterized as an “early adopter”), whereas a customer of type 1 does not lose much utility from his product as it ages (such a customer might be called a “slow replacer”).

Product replacement cost is q=$500.

It is also assumed that there is no salvage value for the product at the end of the horizon. Thus, sₐ=0 for all a.

Future cash flow is not discounted, so the discount factor is α=1.

When a product breaks, the customer's out-of-warranty repair cost is a constant c=$100. (This is an oversimplification of reality, but it helps to make the example easier to follow. In general the repair costs for products of the same model or type would vary depending on the type of failure that had occurred. They would be monitored and tracked to come up with a distribution of repair costs at each age.)

The cost to the provider to repair a product is β=50% of the out-of-warranty . repair cost for the same repair. Thus, the provider earns (1−β)=50% margin on out-of-warranty repairs, equal to $50 for each repair in this hypothetical situation.

When a customer repairs a product out-of-warranty, he goes to the OEM for the repairs ω=30% of the time.

In the particular hypothetical example chosen we assume a monthly EW with no refund or copayment. The monthly premium is assumed to be a constant pₘ=$2.50. For each customer class, the dynamic difference equations can be simplified as follows. The keep or replace decision (where c>0, a≧1) can be characterized as:

Vₙ(c, a, 0)=max{Wₙ(a)−c, Wₙ(0)−q, Vₙ₋₁(c, a+1,0)}, (37)

Vₙ(c, a, 1)=Vₙ(0, a, Z)=max{Wₙ(a), Wₙ(0)−q}, where Z=0, 1. (38)

Equation 37 represents the situation where the customer faces a nonfunctioning product whose failure in the prior month was not covered by a warranty. Thus the customer must choose between repairing the product at his own expense c and then continuing with a product of age a (thus obtaining an expected discounted net utility of Wₙ(a) from that point on), replacing it at cost q and continuing with a new product (obtaining Wₙ(0) expected discounted net utility from that point on), or take no action in this period and continuing in the following period with a nonfunctioning product of age a+1 and earning only Vₙ₋₁(c, a+1, 0) expected discounted net utility from that point on.

Equation 38 represents three cases in which the customer faces identical choices. And the expression Vₙ(c, a, 1) corresponds to a customer who has a nonfunctioning product for which the preceding month's failure was covered under warranty. Therefore, in this hypothetical, the customer can have the product repaired at no cost to him. The expression Vₙ(0, a, Z) represents a customer whose PC is functioning, and so his coverage state of Z in the preceding period does not affect his decisions at this stage. In any of these cases the customer must choose between keeping the product and then continuing with a product of age a (thus obtaining an expected discounted net utility of Wₙ(a) from that point on), or choosing to replace the product at a cost q and continuing with a new product (obtaining Wₙ(0) expected discounted net utility from that point on).

The customer's coverage decision can be expressed as follows.

Wₙ(a)=uₐ+max{Vₙ₋₁(0, a+1,1)−pₘ, ((1−fₐ)Vₙ₋₁(0, a+1,0)+fₐVₙ₋₁(c, a+1,0))}. (39)

Equation 39 represents a customer's coverage decision when there is a functioning product of age a with n periods remaining after making maintenance or replacement decisions in this period. The customer earns a utility uₐ from the product in this period and has two choices to make regarding warranty coverage.
One choice is to purchase coverage for the month at a price of pₘ. Then in the following period, with (n−1) periods remaining and a product age of (a+1), the ongoing expected discounted net utility is Vₙ₋₁(0, a+1, 0) or Vₙ₋₁(c, a+1, 1). (Recall that Vₙ₋₁(0, a+1, 1)=Vₙ₋₁(c, a+1, 1).)
The second choice is not to purchase coverage for that month. Then with a probability fₐ the customer will find a failed, uncovered product of age (a+1) in the next period with an ongoing net utility of Vₙ₋₁(c, a+1, 0). And with a probability (1−fₐ), the customer will have a functioning, uncovered product of age (a+1) with an ongoing net utility of Vₙ₋₁(0, a+1, 0).

The boundary conditions are:

W₀(a)=0,

V₀(0, a, Z)=0 and

V₀(c, a, Z)=0.

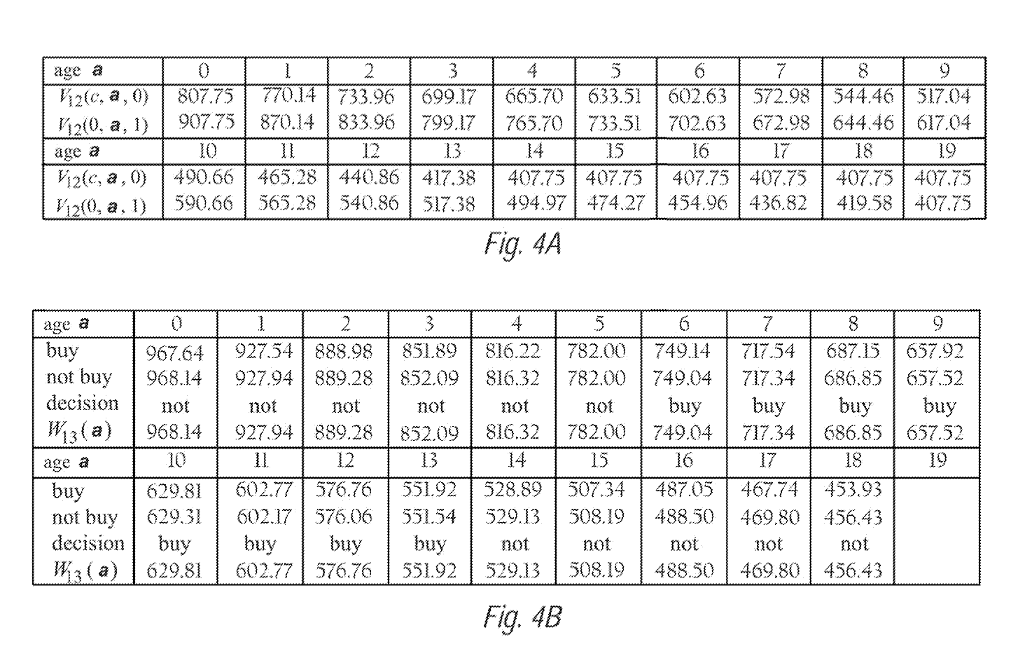

According to the dynamic difference equations (37)-(39) above, since the boundary conditions are known, it is possible to compute the customer's expected discounted value Vₙ over the next n months before making a replacement decision looking backward from n=1 and find the optimal policy for each state. For purposes of this example we consider a customer class 2. For instance, when the time to go is n=12, we obtain the values for V₁₂ in the Table shown in FIG. 4A after performing some computation. It is now possible to show what the customer's optimal policy looks like and how to find it.

To determine the customer's optimal economic decisions when n=13, i.e., when there are 13 periods remaining in the horizon, consider the decisions that the customer must make if the product age is a=5 as an example. According to equation 39 the customer decides between purchasing coverage for the month at a cost of pₘ=$2.50 and then incurring an expected discounted net utility of V₁₂(0, 6, 1)=$702.63 (as shown in the Table in FIG. 4A, row 3 column numbered 6) from that point onward, leading to a total expected discounted net utility of $702.63−$2.50=$700.13 for this choice, or not covering the product and incurring an expected discounted net utility of

$$\begin{matrix}( 1 - {f}_{a} ) {V}_{12} ( 0 , 6 , 0 ) + {f}_{a} {V}_{12} ( c , 6 , 0 ) = ( 1 - 0.026 ) ( \$702 .63 ) + \\ ( 0.026 ) ( \$602 .63 ) \\ = \$684 .36 + \$15 .67\end{matrix}$$

or a total of $700.03 from that point onward. And since $700.03>$700.13 the customer preference is to purchase coverage (albeit a very small preference), and

W₁₃(5)=u₅+$700.13=$81.87+$700.13=$782.

This is shown in the table of FIG. 4B at column (age) a=5 and row 5 representing W₁₃(5).

Before making the repair-replace decision for n=13 months at an age a=5, it is necessary to compute W₁₃(0), which is the expected discounted net utility if the customer replaces the product in n=13 months, which can be obtained by considering the coverage decision (Eqn. 39) for a new product (i.e., a=0) in n=13 months. If the customer purchases coverage for a new product in n =13, the total expected discounted net utility is

u₀−pₘ+V₁₂(0, 1, 1)=$100−$2.50+$870.14=$967.64. (See second column, second row of FIG. 4B.) But if the customer does not purchase warranty coverage, the total expected discounted net utility is

u₀(1−f₀)V₁₂(0, 1, 0)+f₀V₁₂(c, 1, 0)=$100+(1−0.02)($870.14)+0.02($770.14)=$968.14.

(See second column, third row of FIG. 4B)

And since $968.14>$967.64, the customer prefers slightly not to purchase coverage and W₁₃(0)=$968.14. This is reflected in the table shown in FIG. 4B, showing the optimal coverage decisions for different product ages when n=13 months (see rows 4 and 9 labeled “decision”). For this customer class it is optimal not to purchase coverage for products of age a=5 or less, but it is optimal to purchase coverage for products of age a between 7 and 13. And then it is not optimal to purchase coverage for products older than 13.

The repair-replace decision: for n=13 and a=5, where there are several situations to consider. If the product is not functioning and its most recent failure was not under warranty, then the customer is in state (c, 5, 0). If the product is functioning, then the customer is in state (0, 5, 0) or (0, 5, 1). If the product is nonfunctioning, but its failure was covered under a warranty, then the customer is in state (c, 5, 1).

From the customer's perspective, these four cases can effectively be grouped into two states.
State (c, 5, 0): nonfunctioning, uncovered product.
The customer must decide between three choices:
(1) repairing the product, leading to expected discounted net utility of W₁₃(5)−c=$782−$100=$682;
(2) replacing the product, leading to an expected discounted net utility of W₁₃(0)−q=W₁₃(0)−$500=$968.14−$500=$468.14; or
(3) taking no action, leading to expected discounted net utility of V₁₂(c, 6, 0)=$602.63. So this class of customer will choose’ to repair the product and V₁₃(c, 5, 0)=$682.
States (c, 5, 1), (0, 5, 0), or (0, 5, 1): functioning and/or covered products.
The customer must decide between two choices:
(1) keeping the product, leading to an expected discounted net utility W₁₃(5)=$782;
(2) replacing the product, leading to an expected discounted net utility W₁₃(0)−q=$468.14. So clearly the customer will keep the product and V₁₃(c, 5, 1)=V₁₃(0, 5, 0)=V₁₃(0, 5, 1)=$782.

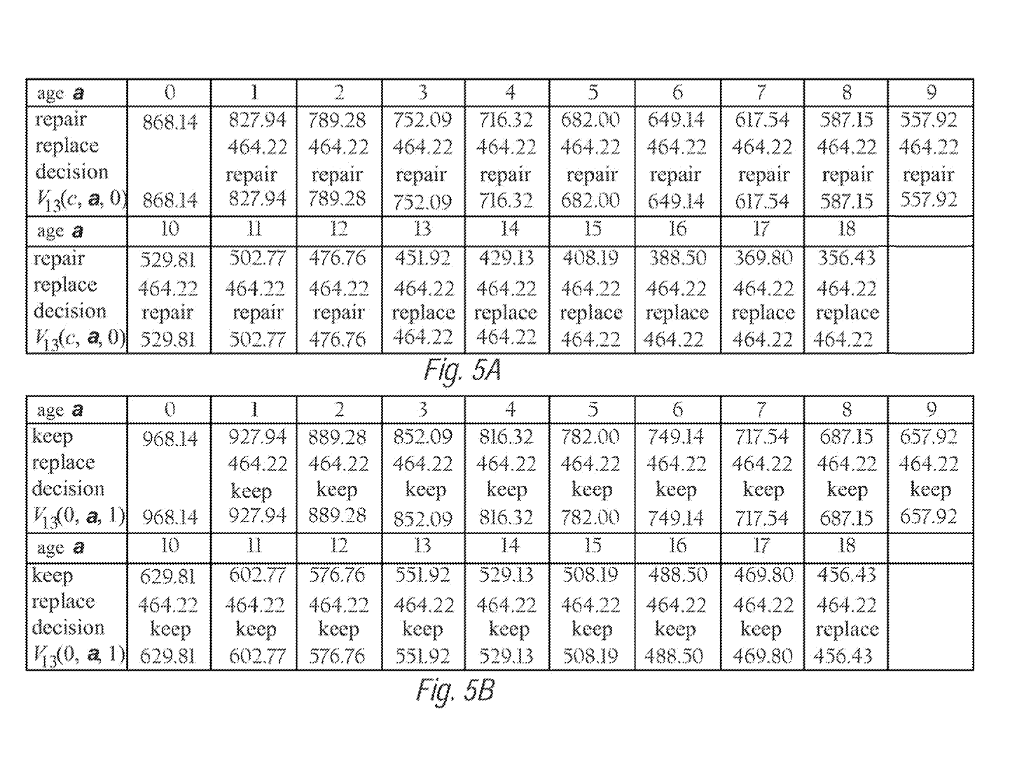

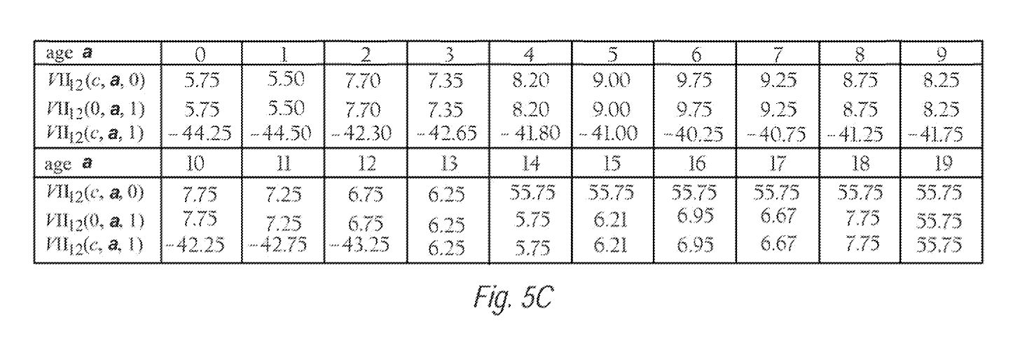

The preceding example illustrates how to compute the maximum expected discounted values W₁₃ and V₁₂, exemplifying how the difference equations are computed backwards from n=1. The two tables shown in FIGS. 5A and 5B show the calculated optimal economic decisions and the corresponding values for different states for n=13. In this example the optimal policy has an age threshold structure showing that the customer will replace the product only when it is beyond a certain age, and the customer will replace a nonfunctioning product earlier than a functioning one which stands to reason given the situation.

The Manufacturer's or Service Provider's Expected Discounted Profit

If we consider the same example as above, we can obtain the service provider's expected discounted profits when there are n=12 periods remaining, VΠ₁₂, in the table shown in FIG. 5C, after performing the calculations. We can also reconsider the customer's decisions when n=13 and a=5, and look at the implications of those decisions to the provider.

First consider the coverage decisions. The customer decides to buy coverage for a functioning product when n=13 and a=5, since

V₁₂(0, 6, 1)−pₘ>[(1−fₐ)V₁₂(0, 6, 0)+fₐV₁₂(c, 6, 0)].

As a result of this choice; from equation (13) above, we know that:

$$\begin{matrix}W {Π}_{13} ( 5 ) = {p}_{m} + ( 1 - {f}_{a} ) V {Π}_{12} ( 0 , 6 , 1 ) + {f}_{a} V {Π}_{12} ( c , 6 , 1 ) \\ = \$2 .50 + ( 1 - 0.026 ) V {Π}_{12} ( 0 , 6 , 1 ) + \\ 0.026 V {Π}_{12} ( c , 6 , 1 ) \\ = \$2 .50 + ( 1 - 0.026 ) ( \$9 .75 ) + 0.026 ( - \$40 .25 ) \\ = \$8 .45\end{matrix} \qquad \begin{matrix}( 40 ) \\ \begin{matrix}\begin{matrix}( 41 ) \\ \end{matrix} \\ ( 42 )\end{matrix}\end{matrix}$$

So now consider the implications to the manufacturer/provider of the customer's maintenance and replacement decision in each possible state for n=13 and a=5.
State (c, 5, 0): (nonfunctioning, uncovered product)
The customer's optimal decision in this state was shown above to be repairing the product (at the customer's own expense), since
   W₁₃(5)−c≧max(W₁₃(0)−q, αV₁₂(c, 6, 0)). So the provider's expected discounted profit is governed by equation (8) above, and therefore:

VΠ₁₃(c, 5, 0)=WΠ₁₃(5)=$8.45. (43)
Equation (43) assumes the customer had the repair done by a third party. But if the customer brought his out-of-warranty product to the provider to be repaired, the provider earns an extra profit on the repair of (1−β)c=$50. And if, for example, this provider has a 30% market share (ω=30%) on such out-of-warranty repairs, then the customer brings .his repair to this provider with a probability of ω. Then we would include an additional ω($50) in profit for this example, i.e.,

$$\begin{matrix}V {Π}_{13} ( c , 5 , 0 ) = ω ( 1 - β ) c + W {Π}_{13} ( 5 ) \\ = ( 0.3 ) ( 0.5 ) ( \$100 ) + \$8 .45 \\ = \$23 .45 .\end{matrix} \qquad ( 44 )$$

State (c, 5, 1): (nonfunctioning, covered product)
In this state as shown above, the customer's preference was to keep the product after having it repaired at the provider's expense, since

W₁₃(5)≧max(W₁₃(0)−q, V₁₂(c, 6, 0)).
Then by equation (4) above, the provider's expected discounted profit is:

VΠ₁₃(c, 5, 1)=−βc+WΠ₁₃(5)=−(0.5)($100)+$8.45 or $41.55. (45)
State (0, 5, 0) or (0, 5, 1): (functioning products)
In either of these states the customer also prefers to keep the product because

W₁₃(5)>W₁₃(0)−q.
The provider's profits are given by equation (12) above, which in this case is:

VΠ₁₃(0, 5, 0)=VΠ₁₃(0, 5, 1)=WΠ₁₃(5)=$8.45. (46)

This is how the service provider determines the expected discounted profits in each state with n=13 periods (months) remaining and with a product of age a=5.

Designing and Pricing Extended Warranties

The disclosure above characterizes customer utility and provider profits for both monthly and refundable-type of EWs. However, how does one optimally design an EW contract or menu of EW contracts to maximize expected discounted profits? In considering the provider's design and pricing problem, it is best to consider competition, customer heterogeneity, and customer demand for services. There could be a plurality of competing service providers in the market. And in general there is a heterogeneous population of customers, varying in product utility schedules, failure probabilities, repair cost distribution, risk attitudes, price sensitivity, or other attributes. For purposes of one embodiment of this invention, we assume there is a known distribution of customer attribute profiles over the population. Furthermore when presented with multiple service options, customers may choose the services that offer the lowest expected discounted cost or highest expected discounted net utility, or they may be influenced by latent preferences or random errors in measurement that add randomness to their choice. To capture the more general case we formulate a customer demand using a multinomial logit (MNL) model which is a type of customer choice model. When price sensitivity is sufficiently large this model results in customers choosing the maximum utility option. At the other extreme, when price sensitivity is zero, customers are equally likely to choose any of the options, regardless of utility.

Suppose that the customer population consists of set of I different types of customers. Then let g(i) be the percentage of the customer population that is of type i, where i=1, . . . , I and Σᵢ₌₁^{I}g(i)=1. We can thus think of g(i) as representing the probability that a randomly selected customer is of type i.

Suppose also that there is a set of services S available in the marketplace. For a given service {s ∈ S}, let (pₛ) be a vector representing the design parameters of the service s, including the warranty price per period for each product age, any copayment, its refund schedule, etc. Then let Uₛⁱ(pₛ) be the maximum expected discounted net utility over an N-period horizon for a customer of type i who can choose between corresponding expected discounted profits for the provider of service s, pay-as-you-go service, and product replacement. Then let Zₛⁱ(pₛ) be the corresponding expected discounted profits for the provider of service s, including profits from service, replacements and pay-as-you-go repairs from a customer of type i, given design vector (pₛ) for the service. Note that the service profits to the provider may be zero if the customer opts not to buy the service with attributes (pₛ). The quantities Uₛⁱ(pₛ) and Zₛⁱ(pₛ) can be computed in accordance with the dynamic equations (1-14) above when s represents a monthly EW, and (15-36) in the case that s represents a refundable EW above. For example ifs is a monthly EW as described earlier, then

Uₛⁱ(pₛ)=W_{N}(0) and Zₛⁱ(pₛ)=WΠ_{N}(0)

If instead s is a refundable EW as also described above, then

Uₛⁱ(pₛ)=W_{N}(0,0) and Zₛⁱ(pₛ)=WΠ_{N}(0,0).

(The dependence of W_{N} and WΠ_{N} on i and pₛ is implicit.)

We assume that the customer demand for services is driven by a multinomial logit model. In particular a customer of type i who is faced with the choice among services {s ∈ S} will choose service s with a probability equal to:

$${π}_{S}^{i} ( p ) = \frac{{e}^{{y}_{i} {U}_{S}^{i} ( {p}_{S} )}}{{\sum }_{t ∈ S} {e}^{{Y}_{i} {U}_{t}^{i} ( {p}_{t} )}} \qquad ( 47 )$$

where γᵢ is a choice sensitivity parameter for customers of type i and p=(pᵢ, . . . , pₛ) is a matrix containing the design parameters for all services available on the market. In this embodiment we assume that if a customer selects a service s at the beginning of the horizon, then that customer will buy the same service thereafter.

From the perspective of a service provider who offers a subset of those services, T ⊂ S, he wants to maximize expected discounted profits from these services given the design parameters of competitor's services in S/T. The provider's problem is that of finding design parameters {pₜ, t ∈ T} to maximize his total expected discounted profits of:

$${\sum }_{t ∈ T} {\sum }_{i ∈ l} g ( i ) {π}_{t}^{i} ( p ) {Z}_{t}^{i} ( {p}_{t} ) . \qquad ( 48 )$$

The provider's problem of finding design parameters {pₜ, t ∈ T} is a nonlinear optimization problem. One could implement any of several well-known optimization procedures, such as line search, to find the optimal parameters.

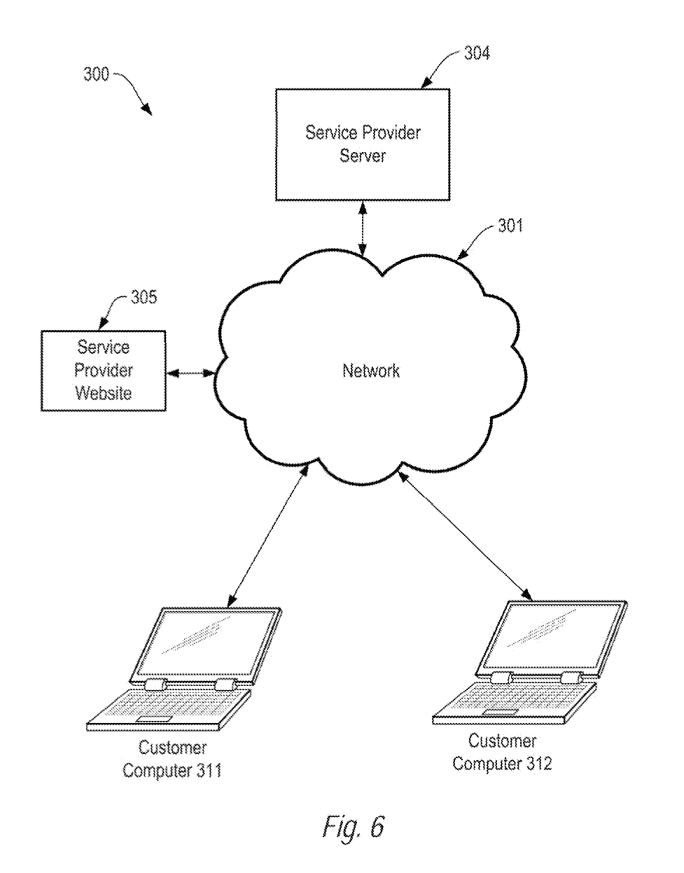

Referring to FIG. 6 according to another aspect of this invention we have shown a customer service 300 wherein a multitude of customers can access information about their particular products and receive feedback information regarding their optimal dynamic maintenance, replacement and warranty coverage decisions for their specific product. Each such customer 311 and 312 can access the service provider's website 305 through network 301 (Internet). (Alternatively customers could access the same service provider through a phone network 301 and enter information, for example, through a keypad or verbally to a service representative, indirectly causing the service provider's computers to generate the optimum dynamic decisions for his particular product. In such an embodiment the customers would not access directly a website 305. And in another possible embodiment, the customer could visit the customer service provider's facility and enter information via local terminals set up for such purpose.) The service provider's server 304 has stored therein all the information regarding the customer's products (failure rates, repair and replacement costs, warranty premium schedules, warranty restriction and cancellation fees, if any) and the dynamic programming model discussed above. Once the customer inputs the data unique to him and product information (product age “a,” how long he would like to keep and utilize the product, whether the product is functional or not, and his customer preferences, i.e., customer type), server 304 can utilize the dynamic programming discussed above to output back to each such customer his unique optimal dynamic maintenance, replacement and warranty coverage decisions for that product at that particular time. None of this information would otherwise be available to these customers for the reasons previously mentioned. The service provider of system 300 could be the same as the EW service provider discussed above, or it could be a completely separate organization charging a fee for each use of the service or simply a monthly fee. Not shown in FIG. 6 are all the usual customer verification protocols and other checking that is done to verify that a customer is a valid subscriber at an authorized IP address and is who he purports to be (i.e., secure passwords) when requesting personal data from the service provider's database.

While aspects of the present invention have been described with reference to certain embodiments, it will be understood by those skilled in the art that various changes may be made and equivalents may be substituted without departing from the scope of the representative embodiments of the present invention. In addition, many modifications may be made to adapt a particular situation to the teachings of a representative embodiment of the present invention without departing from its scope. Therefore, it is intended that embodiments of the present invention not be limited to the particular embodiments disclosed herein, but that representative embodiments of the present invention include all embodiments falling within the scope of the appended claims.

What is claimed is:

1. A method of determining the design parameters a service provider should use for a refundable periodic product warranty offered to a plurality of customers, said method comprising:
selecting a design parameter vector p to maximize
$${\sum }_{i ∈ l} g ( i ) {π}^{ i} ( p ) {Z}^{i} ( p )$$
where,
p represents the design parameters of the refundable periodic warranty, including at least one of: the warranty price per period for each product age, a copayment, and a refund schedule;
g(i) represents the percentage of the population being of customer type i;
I represents the set of customer types;
πⁱ(p) represents the probability that a customer of type i will buy the refundable product warranty given the alternatives available; and
Zⁱ(p) represents the service provider's expected discounted profit from a single customer of type i who is offered a refundable warranty with design parameters p.

2. The method of claim 1 wherein the probability πⁱ(p) is determined based on the customer's expected discounted net utility from a refundable periodic warranty.

3. The method of claim 1 wherein the service provider's expected discounted profit from product replacements, out-of-warranty repairs and warranty sales from a single customer further comprises performing the following steps in each predetermined time period:
determining the customer's maintenance and replacement decision based on the functional state of the product;
computing the service provider's expected discounted profit ensuing from the maintenance and replacement decision;
determining the customer's warranty coverage decision, and
computing the service provider's expected discounted profit ensuing from the customer's warranty coverage decision determined in the above step.

4. The method of claim 1 wherein the refundable warranty period begins when the product is new.

5. The method of claim 2 in which calculating the customer's discounted expected net utility from a refundable warranty further comprises:
performing the following steps in each warranty period:
selecting the customer's maintenance and replacement decision based on at least one of the following factors: the functional state of the product, the product age, the coverage status of the product, and the number of periods left in the horizon;
computing the expected discounted net utility from the maintenance and replacement decision;
selecting a warranty coverage decision; and
computing the expected discounted net utility from the warranty coverage decision.

6. The method of claim 1 wherein the customers are allowed to cancel the refundable warranty at any time after beginning the warranty and obtain a partial refund of the warranty price.

7. The method of claim 6 wherein the amount of the partial refund is based upon at least one of the following criteria:
the warranty price, the duration of warranty coverage, the number of claims made against the warranty, the repair cost of any claims made against the warranty, and cancellation penalties.

8. The method of claim 6 wherein the amount of the partial refund is zero.

9. The method of claim 7 wherein the partial refund is given to the customer in the form of a credit toward purchasing future hardware products.

10. The method of claim 7 wherein the partial refund is given to the customer in the form of a credit toward purchasing services from the service provider.

11. The method of claim 7 in which selecting the customer's warranty coverage decision and computing the expected discounted net utility in each predetermined period further comprises:
computing the customer's expected discounted net utility from coverage decision options: don't-buy-coverage, buy-coverage, and cancel-coverage;
selecting the decision that leads to the higher expected discounted future net utility based on the prior computing step; and
determining the expected discounted net utility as the one which ensues from the decision in the prior selecting step.

12. The method of claim 7 in which selecting the customer's maintenance and replacement decision for a functional product and computing the expected discounted net utility in each predetermined period further comprises:
computing the customer's expected discounted net utility from maintenance and replacement decision options for a functional product, including: keep and replace decisions;
selecting the decision that leads to the higher expected discounted net utility based upon the prior computing step; and
determining the expected discounted net utility ensuing from the decision in the prior selecting step.

13. The method of claim 7 in which selecting the customer's maintenance and replacement decision for a functional product and computing the expected discounted net utility in each predetermined period further comprises:
computing the customer's expected discounted net utility from maintenance and replacement decision options for nonfunctioning products, including: claim-repair, pay-for-repair, replace, and do-nothing decisions;
selecting the decision that leads to the higher expected discounted future net utility based upon the prior computing step; and,
determining the expected discounted net utility as the one which ensues from the decision in the prior selecting step.

14. A computer analysis tool for determining the optimum design parameters a service provider should use to provide a refundable product warranty to a plurality of customers to optimize the service provider's profits generated from selling the refundable product warranties, said computer analysis tool comprising:
a computer system programmed for selecting a design parameter vector p to maximize the expression:
$${\sum }_{i ∈ l} g ( i ) {π}^{i} ( p ) {Z}^{i} ( p )$$
where,
p represents the design parameters of the refundable periodic warranty, including at least one of: the warranty price per period for each product age, a copayment, and a refund schedule;
g(i) represents the percentage of the population being of customer type i;
I represents the set of customer types;
πⁱ(p) represents the probability that a customer of type i will buy the refundable warranty given the alternatives available, and
Zⁱ(p) represents the service provider's expected profit from a single customer of type i who is offered a refundable warranty with design parameters p;
wherein the computer programming is stored on a tangible medium.

15. A computer analysis tool as in claim 14, wherein the probability πⁱ(p) is determined based on the customer's expected discounted net utility from a refundable warranty.

16. A computer analysis tool as in claim 14 further comprising:
an e-commerce server for maintaining a customer and product database comprising a plurality of records of product failure rates, product repair and replacement costs, warranty premium schedules, refund schedules, warranty restrictions and cancellation fees, and customer preferences for various customer types.

17. A method of determining the price a warranty service provider should charge to customers of a partially refundable product warranty comprising:
selecting a price p to maximize the average expected discounted profit per customer over a plurality of types of customers,
wherein the average expected discounted profit per customer for a given price p is determined based on the expected discounted net utility that a customer of each type would derive from a refundable warranty at this price, the probability that a customer of each type would choose the refundable warranty at price p among other alternatives available, the service provider's expected discounted profit from a customer of each type who chooses the refundable warranty at price p among other alternatives available, and the probability distribution over customer types of the population.

18. An automated service for determining a customer's dynamic decisions to maximize the expected discounted net utility when making product replacement decisions, maintenance decisions, and warranty coverage decisions, said service comprising:
a computer system having stored therein a dynamic programming model for assessing during predetermined periods of time customer's dynamic maintenance, replacement and warranty coverage decisions for the customer's products:
a database connected to the computer system containing at least one of the following data: product data failure rates for specific products, customer utility profiles for various customer types, product repair and replacement cost data, warranty premium schedules, product salvage values, warranty restrictions and warranty cancellation fee schedules; and
I/O means for communicating with a customer to solicit specific product information, including product age, failure status, and utility information;
wherein the customer is asked to input his specific product information thereby enabling the computer system to provide the customer with a decision whether to replace a product, repair a failed product, or to purchase, to not purchase, or to cancel warranty coverage in the current period of time.

19. An automated service as in claim 18, wherein the service is web-based.

20. An automated service as in claim 18, wherein the dynamic programming model further comprises:
recursively computing the customer's value functions Vₙ(S) and Wₙ(a) starting from n=0, where
n=the number of remaining periods during which the customer expects to extract a utility from the product;
a=the incremental age of the product measured in the number of periods from the time when the customer first receives the product;
S=(c, a, Z) denotes the state of the product at the beginning of the warranty period before making a replacement decision;
c=the cost to repair a failure, if any, that occurred in the previous warranty period; and
Z=the coverage status in the previous warranty period.

21. A method for determining a customer's dynamic decisions to maximize the customer's discounted expected net utility when making product replacement and refundable warranty coverage decisions comprising:
recursively computing the customer's value functions Vₙ(S) and Wₙ(a) starting from n=0, where
n=the number of remaining periods during which the customer expects to extract a utility from the product;
a=the incremental age of the product measured in the number of periods from the time when the customer first receives the product;
S=(c, a, Z) denotes the state of the product at the beginning of a period before making a replacement decision;
c=the cost to repair a failure, if any, that occurred in the previous period; and
Z=the coverage status in the previous period.

22. The method of claim 21 wherein the period length is one month.
